(19) United States
(12) Patent Application Publication
(10) Pub. No.: US 2006/0081008 A1
(43) Pub. Date: Apr. 20, 2006

(54) Method for manufacturing synthetic silica glass substrate for photomask and synthetic silica glass substrate for photomask manufactured thereby

(75) Inventors: Hiroyasu Hirata, Hadano City (JP); Yuji Fukasawa, Hadano City (JP); Masanobu Ezaki, Hadano City (JP)

Correspondence Address: FOLEY AND LARDNER LLP;SUITE 500, 3000 K STREET NW, WASHINGTON, DC, 20007, US

(73) Assignee: TOSHIBA CERAMICS CO., LTD.

(21) Appl. No.: 11/248,185

(22) Filed: Oct. 13, 2005

(30) Foreign Application Priority Data
Oct. 15, 2004 (JP) 2004-301090
Jan. 20, 2005 (JP) 2005-012208
Sep. 2, 2005 (JP) 2005-254438

(51) Int. Cl. C03B 32/00; C03C 17/00; C03C 23/00; C03C 15/00; C03C 19/00; C03C 21/00

(52) U.S. Cl. 65/111; 65/61

(57) ABSTRACT

The invention provides a method for efficiently manufacturing a synthetic silica glass substrate for photomasks excellent in light stability and capable of being applied to ArF-Wet photolithography with maximum birefringence of 1.4 nm/cm or less, homogeneity of diffractive index of 2×10⁻⁵ or less and an average content of hydrogen atoms of 10¹⁸ to 10¹⁹, comprising the steps of: forming a mask-plain substrate by slicing a block of a synthetic silica glass; heating each sheet of the mask-plain substrate at a temperature of 1100° C. or more; slowly cooling the substrate at a cooling rate of 0.01 to 0.8° C./min; and placing the substrate in a hydrogen gas atmosphere at least at the latter half of the slow cooling step or after the slow cooling step.

### BACKGROUND OF THE INVENTION

1. Field of the Invention

The present invention relates a method for manufacturing a synthetic silica glass substrate that serves as a substrate of photomasks used in photolithography, particularly in immersion photolithography, and a synthetic silica glass substrate for photomasks.

2. Description of the Related Art

A synthetic silica glass is used as a photomask substrate for IC lithography since the glass has a low thermal expansion coefficient and is excellent in light transmittance.

Shorter wavelength light is being employed year by year for the purpose of improving integration performance of ICs, and an ArF excimer laser (“ArF-Dry” laser technology with a wavelength of 193 nm) is currently used.

Since resolution of photolithography using this light source is improved (estimated to be 55 nm) by an ArF immersion technology (“ArF-Wet” laser technology) in which a liquid is filled between a lens and a wafer, this technique is expected to be practically used soon as a technology for substituting F₂ excimer laser (a wavelength of 157 nm), which has been considered to be a light source of photolithography of next generation, with a node width of 65 nm.

A photomask used in this ArF-Wet laser technology is required to have low birefringence for suppressing polarization of light that permeates through the photomask.

Generally, as a method for manufacturing the synthetic silica glass substrate for photomasks, the following method has been known: a block of the synthetic glass is maintained at a temperature above an annealing temperature followed by an annealing treatment for slowly decreasing the temperature at a temperature not higher than a strain point to reduce thermal residual stress, the resulting glass block is sliced, and the substrate obtained is subjected to chamfering and abrasive finishing (see Japanese Patent Application Laid-Open (JP-A) No. 2000-330263). The highest birefringence of commercially available optical glasses having the lowest level of birefringence is 5 nm/cm (for example, trade name “Homosil” manufactured by Sinetsu Quartz Co.).

Although shift of surface wavefront of such optical glass is not defective by considering it to be within a practically permissible range of variation of the refractive index (not larger than ¼of the wavelength) so long as there are no bubbles, grains and striae, birefringence as a result of thermal residual stress may be of problem when the glass is used for a precision mask for ArF-Wet photolithography, and detection of a short wavelength difference in the order of ¼of the wavelength, or 1 nm/cm or less in a specification, is required.

Methods in which annealing of the block of the synthetic silica glass has been improved by various ways are known in the art as the method for manufacturing the synthetic silica glass for photomasks for dealing with the problems above (JP-A Nos. 2000-264671, 2001-19465, 2001-89170 and 2003-292328).

However, although the block (ingot) of the synthetic glass before processing into the substrate is annealed in the method for manufacturing conventional synthetic silica glass substrates for photomasks, the manufacturing process requires a step for maintaining the block at a temperature as high as 1150° C. or more for 50 hours or more in addition to a cooling step for 50 hours or more in order to maintain the temperature of the entire block uniform to avoid the annealing step from being different among the lots, because of low heat conductivity characteristics of the silica glass. Therefore, such manufacturing step requires a long term treatment.

Since a temperature distribution tends to occur throughout the block, it was difficult to sufficiently reduce irregularity of average birefringence and diffraction index (homogeneity of diffraction index).

### SUMMARY OF THE INVENTION

Accordingly, the method required for manufacturing the synthetic silica glass for photomask substrates comprises the steps of soaking the glass block within a short period of time in the annealing treatment, and reducing the average birefringence and the difference of birefringence, or improving light stability.

An object of the invention has made for solving the technical problems described above is to provide a method for efficiently manufacturing a synthetic silica glass substrate for photomasks capable of being applied to ArF-Wet photolithography and being excellent in light stability, and a synthetic silica glass substrate for photomasks.

The invention provides a method for efficiently manufacturing a synthetic silica glass substrate for photomasks comprising the steps of: preparing a mask-plain substrate by slicing a block of a synthetic silica glass; heating the mask-plain substrate at a temperature of 1100° C. or more; slowly cooling the substrate at a cooling rate at 0.01° C./min or more and 0.8° C./min or less; and maintaining the atmosphere to be a hydrogen atmosphere at least at a latter half of the slow cooling step or after the slow cooling step.

As mentioned above, the structural relaxation of the glass substrate is conducted by an annealing treatment after processing the block of the synthetic silica into the mask-plain substrate in order to allow hydrogen molecules to be diffused by a hydrogen treatment at a lower temperature. This process permits the annealing time to be shortened and hydrogen to be uniformly doped to enable the synthetic silica glass substrate for photomasks excellent in light stability to be efficiently obtained.

The block of the synthetic silica glass has maximum birefringence of 10 to 15 nm/cm and homogeneity of diffraction coefficient of 10⁻⁵ or less ,and preferably does not emit fluorescence by irradiating with a low pressure mercury lamp.

The synthetic silica glass used in the invention preferably comprises the characteristics as described above as the block before being processed into the mask-plain substrate from the view point of processability and applicability to photolithography.

The concentration of hydrogen may be increased again in the manufacturing method above, by treating the mask-plain substrate in a hydrogen atmosphere at the latter half of slow cooling or after slow cooling, after the concentration of hydrogen in the mask-plain substrate has been once decreased by heating individual sheets of the mask-plain substrate at a temperature of 1100° C. or more.

Since the hydrogen concentration in the mask-plain substrate is readily fluctuated by temperatures, the hydrogen concentration may be uniformly controlled by the process described above.

Each sheet of the mask-plain substrate is preferably heated by covering it with a silica heat insulating material, or each sheet of the mask-plain substrate is preferably heated by placing it on a tray made of silicon, carbon or silicon carbide.

The temperature may be kept constant during the annealing treatment and temperature differences around the mask-plain substrate in the slow cooling step may be reduced, the influence of the temperature distribution in a furnace may be diminished, and deformation by the substrate's own weight may be suppressed, by placing the mask-plain substrate in the furnace in the conditions as described above.

The block of the synthetic silica glass used in the manufacturing method above is obtained by a direct melting method, and the glass block preferably has an OH group concentration of 600 to 1,000 ppm.

The block of the synthetic silica glass having the OH group concentration in the range as described above is preferably used as a parent material of the mask-plain substrate in view of the remaining stress and strength and the like.

The block of the synthetic silica glass is preferably cooled slowly at a cooling rate of 0.8 to 1° C./min after heating it at 1100° C. or more in the atmosphere.

Strain is preferably removed before processing into the mask-plain substrate by the annealing treatment as a block.

The synthetic silica glass substrate for photomasks according to the invention is manufactured by the manufacturing method above, and has preferably a maximum birefringence of 1.4 nm/cm or less, homogeneity of the refractive index of 2×10⁻⁵ or less, and an average content of hydrogen atoms of 10¹⁸ to 10¹⁹ ppm.

The synthetic silica glass substrate manufactured by the manufacturing method according to the invention having these characteristics is excellent in light stability, and may be favorably used for ArF-Wet photolithography.

The method for manufacturing the synthetic silica glass substrate for photomasks according to the invention improves the shortening of time for the annealing treatment and homogeneity of hydrogen doping, to obtain the synthetic silica glass substrate for photomasks efficiently.

The synthetic silica glass substrate for photomasks according to the invention obtained by the manufacturing method above is enough for being applied to ArF-Wet photolithography.

The manufacturing method described above may be also used for manufacturing a block of the synthetic silica glass substrate that has been already manufactured in a large scale in practical processes. The annealing treatment and hydrogen treatment of the mask-plain substrate may afford an advantage in the manufacturing cost since these treatments can be applied in the same furnace.

### BRIEF DESCRIPTION OF THE DRAWINGS

FIG. 1 is a graph showing full field distribution of birefringence of the synthetic silica glass substrate for photomasks in Example 1;

FIG. 2 is a graph showing full field distribution of birefringence of the synthetic silica glass substrate for photomasks in Comparative Example 1; and

FIG. 3 is a graph showing full field distribution of birefringence of the synthetic silica glass substrate for photomasks in Example 2.

### DESCRIPTION OF THE PREFERRED EMBODIMENTS

In the method for manufacturing a synthetic silica glass substrate for photomasks, a block of the synthetic silica glass is sliced to form a mask-plain substrate processed into an approximate shape of the mask substrate, each sheet of the mask-plain substrate is heated at a temperature of 1100° C. or more followed by slowly cooling at a cooling rate of 0.01 to 0.8° C., and the atmosphere is maintained to be a hydrogen gas atmosphere at the latter half of the slow cooling step or after the slow cooling step.

In other words, the substrate is annealed and treated with hydrogen after processing into the mask-plain substrate, instead of directly annealing the block of the synthetic silica glass.

Since the mask-plain substrate has a smaller volume than the block (ingot) with a shorter heat transfer distance, the treatments as described above are advantageous in that soaking within a short period of time is possible.

After relaxing the structure of the mask-plain substrate by annealing, hydrogen molecules are diffused into the substrate by a hydrogen treatment at a lower temperature to permit the shortening of annealing time and homogeneity of hydrogen doping, thereby enabling the synthetic silica glass substrate for photomasks excellent in light stability to be more efficiently obtained.

When the temperature for heating each sheet of the mask-plain substrate is below 1100°C., the substrate maybe broken due to temporary strain during the cooling step while it is difficult to remove permanent strain accumulated when the mask-plain substrate formed at a temperature above a strain point is cooled to the strain point.

The heating temperature is preferably 1170° C. or more, and the upper limit thereof is 1180° C.

The time for keeping the substrate at a temperature of 1100° C. or more is preferably 2 to 3 hours, more preferably 5 to 7 hours, although the time depends on the heat capacity of entire articles inserted into the furnace.

All the portions of the mask-plain substrate cannot reach a stationary temperature when the time for keeping the temperature is less than 2 hours, while productivity decreases when the time duration exceeds 7 hours.

The cooling rate of the mask-plain substrate is 0.01 to 0.8° C./min in the manufacturing method described above.

Productivity may decrease when the cooling rate is below 0.01° C., while a cooling rate of exceeding 0.8° C./min would cause birefringence since permanent strain is left behind due to a large temperature difference between the inside and surface of the mask-plain substrate.

Accordingly, the preferable cooling rate is 0.1 to 0.4° C./min.

The substrate is preferably cooled at the cooling rate as described above until the strain point of the synthetic glass of 800° C., and it may be cooled spontaneously thereafter.

In the manufacturing method above, the atmosphere is maintained to be a hydrogen gas atmosphere at least at the latter half of the slow cooling step or after the slow cooling step.

While the atmosphere may be the hydrogen atmosphere from the heating step for annealing, the hydrogen atmosphere is preferably employed in the cooling step or thereafter since the mask-plain substrate is difficult to manipulate in the hydrogen atmosphere at a high temperature of 1100° C. or more with an apprehension of side reactions. For example, the atmosphere is preferably substituted with hydrogen when slow cooling has proceeded to about 900° C., more preferably to about 800° C.

Annealing and treatment in the hydrogen atmosphere may be independently applied, or the substrate may be treated in the hydrogen atmosphere by heating it to 400° C. or more and 800° C. or less again after the substrate has been once cooled.

The hydrogen atmosphere is preferably 10 to 15 L/min of the hydrogen flow rate under a pressure of 1 atm.

The hydrogen concentration in the substrate may be increased in the manufacturing method above by treating it in the hydrogen gas atmosphere at the latter half of the cooling step or after the cooling step, after the hydrogen concentration has been once decreased by heating each sheet of the mask-plain substrate at a temperature of 1100° C. or more.

Since the hydrogen concentration is readily fluctuated with the temperature in the mask-plain substrate thinner than the block, the treatment as described above permits the hydrogen concentration to be uniformly adjusted.

Since the total annealing time is elongated in the annealing treatment of the mask-plain substrate, hydrogen is discharged from the mask-plain substrate during the hydrogen treatment. Red luminescence is observed by irradiating with a KrF excimer laser, an ArF excimer laser or a mercury lamp at the portion containing less hydrogen, and red luminescence is quenched by replenishing hydrogen.

Consequently, the hydrogen treatment as described above is employed for preventing red luminescence during photolithography of the mask-plain substrate.

The block of the synthetic silica glass processed into the mask-plain substrate preferably has a maximum birefringence of 10 to 15 nm/cm and homogeneity of the refractive index of 10⁻⁵ or less.

While the block of the mask-plain substrate involves no problem when birefringence is less than 10 nm/cm, flaws and cracks may be caused during the processing step when birefringence exceeds 15 nm/cm.

When homogeneity of the refractive index of the block of the synthetic silica glass exceeds 10⁻⁵, distortion of transferred images may occur when the block is processed into a mask for applying it to photolithography.

Since the block of the synthetic silica glass is not suitable for photomasks if it emits fluorescence by irradiating with a low pressure mercury lamp (253.7 nm), the block preferably does not emit fluorescence by irradiating with the low pressure mercury lamp.

While the block (ingot) of the synthetic silica glass may be manufactured by a direct method, an indirect method or a sol-gel method, it is preferably obtained by a direct melting method or soot re-melting method, more preferably by the direct melting method. The glass used contains OH groups in a concentration of 600 to 1000 ppm.

Residual stress is hardly removed when the OH concentration is less than 600 ppm, while three-membered ring strength decreases when the concentration exceeds 1000 ppm.

The block of the synthetic silica glass is preferably formed by tapped molding or by melt molding into a rectangular shape for using it as a photomask.

It is preferable for the block of the synthetic silica glass to slowly cool at a cooling rate of 0.8 to 1° C./min after heating at a temperature of 1100° C. or more before slicing the block into the mask-plain substrate.

The block of the synthetic silica glass is temporarily placed in a furnace kept at a temperature of about 600° C. for preventing temporary strain accompanied by rapid cooling after molding at a high temperature, and the block is annealed when the furnace has been full of the blocks.

When the heating temperature in the annealing treatment is less than 1100° C., the block may be broken due to temporary strain while permanent strain, which is accumulated in the step for cooling the block formed at a temperature above the strain point to the strain point, is hardly removed.

The heating temperature is preferably 1170° C. or more, and the upper limit thereof is 1200° C.

The time for keeping the block of the synthetic silica glass at a temperature of 1100° C. or more in the annealing treatment is preferably about 5 hours when the furnace is filled with hot blocks, although the time depends on the capacity (the number of the blocks) of inserted articles in the furnace.

The block does not reach the slow cooling point depending on the place of the block to make it difficult to remove tapping strain when the time for keeping the desired temperature is too short. On the contrary, the block is partially softened and deformed when the time for keeping the temperature is too long.

The cooling rate of the block of the synthetic silica glass after heating is preferably 0.8 to 1° C./min.

A long period of time is required for cooling to result in a decrease productivity, when the cooling rate is lower than 0.8° C./min, while large temporary strain and permanent strain are left behind due to a large temperature difference between the inside and surface of the block, when the cooling rate exceeds 1° C./min.

Accordingly, the temperature is slowly lowered to 800° C. that is the strain point of the synthetic silica glass, and the block may be spontaneously cooled thereafter.

Since deformation such as warp and surge and roughening of the surface ascribed to release of the internal stress occurs by annealing and hydrogen treatment in the mask-plain substrate obtained by slicing the block of the synthetic silica glass, the surface area as well as thickness of the plate are preferably adjusted to be a little larger than the prescribed size (¼inch) of the substrate.

Chamfering, abrasive finish and etching are preferably applied to the substrate prior to annealing for improving precision of the substrate.

It is also preferable to cover each sheet of the substrate with a silica base heat insulating material such as quartz powder before heating in the annealing and hydrogen treatments of the mask-plain substrate.

Specifically, an alumina-silica setter having a sufficiently larger size than the size of the mask-plain substrate is used as a vessel, the sheet of the mask-plain substrate is placed on the natural quartz powder spread on the bottom of the vessel at a thickness of about 10 mm, the circumference faces and upper face of the substrate are covered with the natural quartz powder with the same thickness as the thickness on the bottom, and the vessel is covered with a lid made of the same material as the vessel.

The temperature difference around the mask-plain substrate may be suppressed while the temperature is kept constant and the substrate is cooled by setting the substrate in the vessel as described above. This enables the influence of the temperature distribution in the furnace on the mask-plain substrate to be reduced, and fluctuation of the temperature in the mask-plain substrate to be restricted within ±1.5° C.

When the temperature fluctuation in the sheet of the mask-plain substrate is out of the range of ±1.5° C., birefringence occurs due to viscosity distribution corresponding to the temperature distribution.

Accordingly, the temperature fluctuation is preferably within the range of ±1.0° C.

The sheet of the mask-plain substrate may be heated and cooled on a tray made of silicon, carbon or silicon carbide by the same reason as described above.

The tray is preferably made of silicon since silicon has a high viscosity and high purity, and the thickness of the tray is preferably 0.5 mm or more, more preferably 2 mm or more by taking elastic deformation of the tray into consideration.

It is possible to select a higher cooling rate while maintaining the soaking condition of the mask-plain substrate loaded by using the silicon tray as described above, and the manufacturing time of the synthetic silica glass for photomasks may be shortened.

Actually, each sheet of the mask-plain substrate with a size of 150 mm×150 mm×7 mm is placed on a silicon tray with a diameter of 200 mm, the silicon tray is covered with the same size of another silicon tray to sandwich the substrate between the trays, and four corners of the tray are supported with silica glass braces.

Such arrangement permits deformation of the mask-plain substrate by its own weight during the annealing treatment to be suppressed within 50 μm or less. In addition, plural sheets of the substrate may be laminated for annealing in a vertical furnace while spaces for ensuring heat flow are maintained.

The mask-plain substrate after annealing and hydrogen treatment is subjected to abrasive finish, if necessary, and is finished into a prescribed shape and size of the mask with a desired surface roughness (#500 rap finish) and surface flatness (about 5 μm).

The substrate is further etched with hydrofluoric acid (HF), if necessary, and a synthetic silica glass substrate (a product) for a photomask is manufactured through prescribed product inspections (striae, bubbles, surface defects, inspection of fluorescence, analysis, distribution of transmittance, birefringence and the like).

According to the manufacturing method of the invention as hitherto described, a synthetic silica glass substrate for a photomask with a maximum birefringence of 1.4 nm/cm or less, homogeneity of the refractive index of 2×10⁻⁵ or less, and an average content of hydrogen atoms of 10¹⁸ to 10¹⁹ ppm, or a synthetic silica glass substrate for photomasks being excellent in light stability, can be favorably obtained.

A synthetic silica glass substrate having a maximum birefringence exceeding 1.4 nm/cm is not suitable for precise ArF-Wet photolithography. The maximum birefringence is preferably 1.0 nm/cm or less for the synthetic silica glass substrate for photomasks.

Likewise, homogeneity of the refractive index exceeding 2×10⁻⁵ is not suitable for precise ArF-Wet photolithography. Homogeneity of the refractive index of less than 10⁻⁷ is more preferable for the synthetic silica glass substrate for photomasks.

In the method for manufacturing the synthetic silica glass substrate for photomasks, the temperature distribution in an empty annealing furnace in the area where the mask-plain substrate is placed is preferably within ±2.5° C. of the setting temperature for annealing at a stationary state, and the atmosphere in the furnace is preferably capable of being replaced with a hydrogen gas atmosphere.

Soaking of the mask-plain substrate to be treated and homogeneity of hydrogen doping may become efficient by using the annealing furnace provided with the conditions as described above.

When the temperature distribution in the empty furnace is out of the range of ±2.5° C. of the setting temperature for annealing at a stationary state, the viscosity of the glass will be distributed due to temperature fluctuation in the mask-plain substrate as a result of temperature fluctuation in the furnace. Accordingly, a stress is generated between portions where viscous fluidity could follow the temperature fluctuation and portions where viscous fluidity could not, and this stress could be left behind at room temperature.

While a sequence program for controlling the temperature of the annealing furnace is not particularly concerned with heating up to the annealing temperature and maintaining the temperature, it is preferable to ascertain the time required for each part of the mask-plain substrate to arrive at a stationary temperature in the heating and cooling steps using a dummy article composed of these parts, since the heat capacity is increased by using the setter, natural quartz powder or tray.

When the mask-plain substrate is cooled before each part of the mask-plain substrate does not arrive at a stationary temperature in the cooling step, temperature fluctuation increases within the mask-plain substrate, and residual thermal stress may become complicated since the portion where temperature increase is retarded is cooled before the portion arrives at the annealing temperature.

### EXAMPLE

While the invention is described in more detail hereinafter with reference to examples, the invention is by no means restricted by the examples below.

### Example 1

A synthetic silica glass manufactured by Verneuil method (trade name T-4042, manufactured by Toshiba Ceramics Co.) was tap molded or molded into a rectangular shape into a block (155 mm×155 mm×200 mm).

This block of the synthetic silica glass was temporarily placed in a furnace with an atmosphere kept at 600° C. for preventing defects and cracks from occurring by cooling after molding at a high temperature.

The block of the synthetic silica glass had an OH group concentration of 800 ppm with birefringence of 13 nm/cm and homogeneity of the refractive index of 10⁻⁶, and emitted any fluorescence by irradiating with a low pressure mercury lamp.

Then, the furnace was heated to a temperature of 1180° C. at a heating rate of 1.7° C./min after the furnace had been full of the blocks of the synthetic silica glass, and was slowly cooled to 800° C. at a cooling rate of about 1° C./min after keeping the temperature for 5 hours, followed by spontaneous cooling to room temperature.

The block of the synthetic silica glass was sliced into mask-plain substrates with a surface area of 153 mm square and a thickness of 8.08 mm.

Subsequently, the mask-plain substrate was placed on an alumina-silica setter (254 mm square, depth 30 mm) on the bottom of which natural quartz powder was spread at a thickness of about 10 mm, the circumference and top face of the mask-plain substrate was surrounded with natural quartz powder at a thickness of about 10 mm, and the setter was covered with another setter having a similar size.

The covered setter was placed in an annealing furnace, in which the temperature distribution in the empty furnace was controlled within ±2.5° C. of the setting temperature for annealing at the area (center of the furnace) where the mask-plain substrate is to be placed, and in which the atmosphere in the furnace was replaced with a hydrogen atmosphere. The temperature of the furnace was increased to 1170° C. thereafter while hydrogen gas is allowed to flow at a flow rate of 15 L/min, and the temperature was maintained for 8 hours.

Then, the furnace was slowly cooled to 800° C. at a cooling rate of 0.4 C./min, and the furnace was allowed to spontaneously cool by turning the heater of the furnace off when the temperature had decreased below 800° C. Hydrogen gas flow was stopped when the temperature was decreased to approximately room temperature.

The mask-plain substrate was taken out of the annealing furnace, and transparent abrasive finish was applied on the circumference face while both surfaces were grinded until the thickness of the plate is adjusted to 7.08 mm. The surfaces were further subjected to abrasive finish to a thickness of 6.4 mm as the circumference faces were, and were slightly etched with hydrofluoric acid to obtain the synthetic silica glass for photomasks.

No emission of red fluorescence was observed in the inspection by irradiating the synthetic silica glass for photomasks with a low pressure mercury lamp.

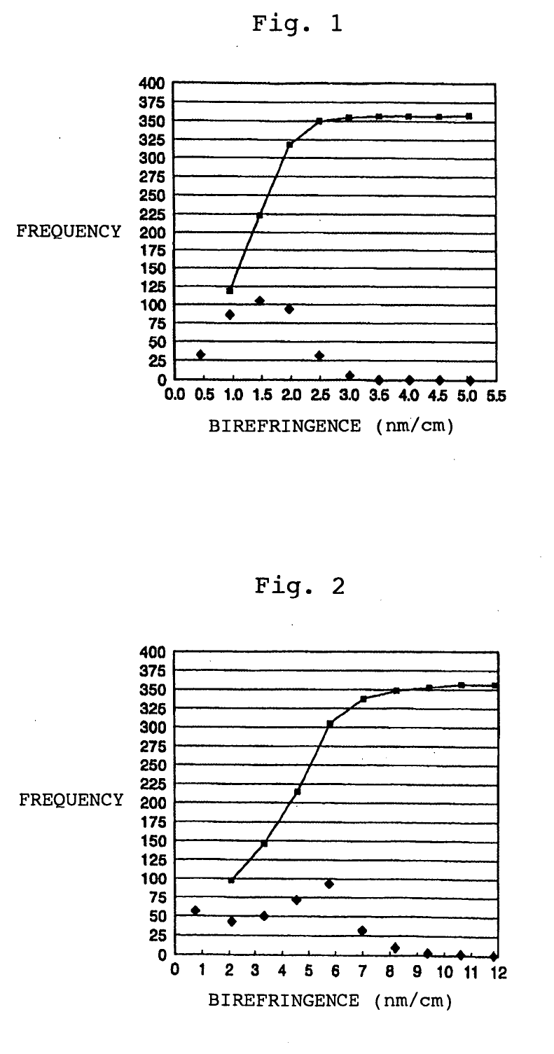

The entire field of the surface of the synthetic silica glass for photomasks was scanned with a birefringence meter (trade name EXICOR, manufactured by HIND Co.) using HeNe laser (wavelength 633 nm) as a standard laser light. A graphic representation of in-plane distribution of birefringence is shown in FIG. 1.

FIG. 1 shows that average birefringence (Bf₅₀) was 1.4 nm/cm, and the area ratio of the surface having birefringence of 1 nm/cm or less was 35% relative to 100% of the entire field.

A mask-plain substrate with an area of 153 mm square and a thickness of 7.08 mm was prepared by slicing the block of the synthetic silica glass by the same manner as in Example 1. This mask-plain substrate was subjected to transparent grinding on the circumference faces and transparent abrasive finish on both surfaces to a thickness of 6.4 mm as in Example 1, and the synthetic silica glass substrate for photomasks was obtained by gently etching the surfaces with hydrofluoric acid.

No emission of red fluorescence was observed upon inspection of the synthetic silica glass substrate for photomasks by irradiating with a low pressure mercury lamp.

The entire field of the synthetic silica glass substrate for photomasks was scanned with a birefringence meter. A graphic representation of in-plane distribution of birefringence is shown in FIG. 2.

FIG. 2 shows that average birefringence was 4.2 nm/cm, and the area ratio of the surface having birefringence of 1 nm/cm or less was 17% relative to 100% of the entire field.

FIGS. 1 and 2 show that average birefringence was reduced from 4.2 nm/cm to 1.4 nm/cm, and the area ratio of the surface having birefringence of 1 nm/cm or less was increased from 17% to 35% by annealing of the mask-plain substrate in a hydrogen atmosphere. The degree of strain as a cause of birefringence was improved (decreased), and it was verified that residual stress is released and removed by annealing in the hydrogen atmosphere.

### Example 2

A block of the synthetic silica glass was sliced as same manner in Example 1 to prepare a mask-plain substrate with an area of 153 mm square and a thickness of 7.08 mm. After heating this mask-plain substrate in a hydrogen atmosphere in an annealing furnace as in Example 1, the substrate was heated to 800° C. at a heating rate of 0.15° C./min followed by slow cooling, and the substrate was spontaneously cooled by turning the heater of the furnace off at a temperature of 800° C. or less.

The mask-plain substrate was taken out of the annealing furnace, and transparent abrasive finish was applied on the circumference face while both surfaces were grinded until the thickness of the plate is adjusted to 7.08 mm. The surfaces were further subjected to abrasive finish to a thickness of 6.4 mm as the circumference faces were, and were slightly etched with hydrofluoric acid to obtain the synthetic silica glass for photomasks.

No emission of red fluorescence was observed in the inspection by irradiating the synthetic silica glass for photomasks with a low pressure mercury lamp.

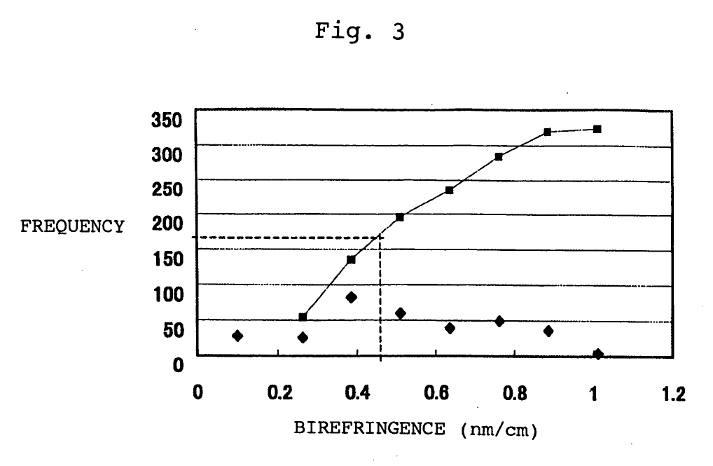

The entire field of the surface of the synthetic silica glass for photomasks was scanned. A graphic representation of in-plane distribution of birefringence is shown in FIG. 3.

FIG. 3 shows that average birefringence was 0.46 nm/cm, maximum birefringence was 1.0 nm/cm, and the entire surface showed birefringence of 1 nm/cm or less.

### Comparative Example 2

A block of the synthetic silica glass was sliced as same manner in Example 1 to prepare a mask-plain substrate with an area of 153 mm square and a thickness of 7.08 mm. The mask-plain substrate was housed in a setter by covering the substrate with natural quartz powder, and the covered setter was placed at the center of the annealing furnace (an area with temperature fluctuation of within ±2.5° C.). Then, the furnace was heated to 1700° C. at a heating rate of 1.7° C./min as in Example 1, and the temperature was maintained for 8 hours.

The furnace was slowly cooled to 800° C. at a cooling rate of 0.4° C./min, and was spontaneously cooled by turning the heater of the furnace off at a temperature of 800° C. or less.

The mask-plain substrate was taken out of the furnace, the circumference surface was subjected to transparent abrasive finish, and both surfaces were subjected to transparent abrasive finish to a thickness of 6.4 mm followed by gentle etching with hydrofluoric acid to obtain a synthetic silica glass substrate for photomasks.

Red fluorescence was emitted upon inspection of the synthetic silica glass substrate for photomasks by irradiating it with a low pressure mercury lamp.

### Example 3

The synthetic silica glass substrate for photomasks in Comparative Example 2 was subjected to annealing in a hydrogen atmosphere and hydrogen doping (400° C.×48 hours) using a hydrogen furnace as same in Example 1. No red fluorescence was emitted upon inspection with a low pressure mercury lamp.

### Example 4

A block of the synthetic silica glass produced by hydrolysis of silicon tetrachloride with oxygen-hydrogen flame (oxygen:hydrogen=1:2) was sliced to prepare a mask-plain substrate with an area of 152.4 mm square and a thickness of 7.07 mm.

This mask-plain substrate was kept at 1180° C. for 10 hours in air, followed by cooling to 400° C. at a cooling rate of 15° C./min. The substrate was maintained at 400° C. in a hydrogen gas atmosphere under an ambient pressure for hydrogen treatment by which the hydrogen concentration in the mask-plain substrate was adjusted to 1.5×10¹⁸ ppm.

The mask-plain substrate was cut into a size of 12 mm×75 mm×6.35 mm, followed by mirror abrasive finish to form a synthetic silica glass substrate for photomasks.

Light stability of this substrate was evaluated using an excimer laser.

Two kinds of the substrates with OH group concentrations of 950 ppm and 1050 ppm were evaluated. A transmitted light after irradiating the substrate with a deuterium lamp was spectrometrically resolved using a monochrometer to measure transmittance at a wavelength of 195 nm, and a decreasing rate of an ArF excimer laser (wavelength 193 nm) with an energy of 27 mJ/(cm² pulse) before and after irradiation was determined.

The results are shown in Table 1.

Transmittance at the wavelength of 195 nm was measured in order to avoid a light with a wavelength of 193 nm leaking from the excimer laser from being measured.

### Examples 5 and 6

The synthetic silica glass substrates for photomasks with OH group concentrations shown in Examples 5 and 6 in Table 1, which were manufactured by the same manner as in Example 4, were evaluated with respect to light stability by the same manner as in Example 4 by irradiating the ArF excimer laser (wavelength 193 nm) with the energy and irradiation time as shown in Examples 5 and 6.

The results are shown in Table 1.

### Comparative Examples 4 to 6

Synthetic silica glass substrates for photomasks with the OH group concentrations shown in Comparative Examples 4 to 6 in Table 1 were manufactured by the same manner as in Example 4, except that no annealing and hydrogen treatments were applied to the mask-plain substrates. These mask-plain substrates had a hydrogen concentrations of 1.2×10¹⁹ ppm. Light stability was evaluated by the same manner as in Example 4 using the ArF excimer laser (wavelength 193 nm) with the energy and irradiation time shown in Comparative Examples 4 to 6 in Table 1.

The results are shown in Table 1.

TABLE 1

| | Hydrogen | OH Group | ArF Excimer Laser | | Wavelength 195 nm |
|---|---|---|---|---|---|
| | Concentration | Concentration | Energy | Irradiation | Decreasing Rate of |
| | (ppm) | (ppm) | (mJ/(cm² · pulse) | Time (min) | Transmittance (%) |
| Example 4 | 1.5 × 10¹⁸ | 950/1050 | 27 | 5 | ≦0.3 |
| Comparative Example 4 | 1.2 × 10¹⁹ | | | | ≧2.0 |
| Example 5 | 1.5 × 10¹⁸ | 850/900 | 10 | 10 | ≦0.3 |
| Comparative Example 5 | 1.2 × 10¹⁹ | | | | ≧2.0 |
| Example 6 | 1.5 × 10¹⁸ | 1000 | 10 | 60 | ≦0.7 |
| Comparative Example 6 | 1.2 × 10¹⁹ | | | | ≧2.5 |

As Shown in Table 1, it was confirmed that decrease of transmittance of a light with a wavelength of 195 nm when the ArF excimer laser is irradiated is suppressed in the synthetic silica glass substrates for photomasks in Examples 4 to 6.

On the contrary, the rate of decrease of transmittance was large in the synthetic silica glass substrates for photomasks in Comparative Examples 4 to 6, although the hydrogen concentration was high.

The results above show that structural relaxation is possible by applying annealing and hydrogen treatment to the mask-plain substrate with a uniform concentration of hydrogen of 10¹⁸ to 10¹⁸ ppm, thereby enabling light stability to be improved.

What is claimed is:

1. A method for manufacturing a synthetic silica glass substrate for photomasks comprising the steps of:
forming a mask-plain substrate by slicing a block of a synthetic silica glass;
heating each sheet of the mask-plain substrate at a temperature of 1100° C. or more;
slowly cooling the substrate at a cooling rate of 0.01 to 0.8° C./min; and
placing the substrate in a hydrogen gas atmosphere at least at the latter half of the slow cooling step or after the slow cooling step.

2. The method for manufacturing the synthetic silica glass substrate for photomasks according to claim 1, wherein the block of the synthetic silica glass has maximum birefringence of 10 to 15 nm/cm and homogeneity of the refractive index of 10⁻⁵ or less, and does not emit fluorescence by irradiating with a low pressure mercury lamp.

3. The method for manufacturing the synthetic silica glass substrate for photomasks according to claim 1 comprising the steps of:
decreasing the hydrogen concentration in the mask-plain substrate once by heating each sheet of the mask-plain substrate at a temperature of 1100° C. or more; and
increasing the hydrogen concentration again by treating in the hydrogen gas atmosphere at least at the latter half of the slow cooling step or after the slow cooling step.

4. The method for manufacturing the synthetic silica glass substrate for photomasks according to claim 1, wherein each sheet of the mask-plain substrate is covered with a silica base heat insulating material for heating the sheet.

5. The method for manufacturing the synthetic silica glass substrate for photomasks according to claim 1, wherein each sheet of the mask-plain substrate is placed on a tray made of any one of silicon, carbon or silicon carbide for heating the sheet of the synthetic silica glass substrate.

6. The method for manufacturing the synthetic silica glass substrate for photomasks according to claim 1, wherein the block of the synthetic silica glass is manufactured by a direct melting method with an OH group concentration of 600 to 1000 ppm.

7. The method for manufacturing the synthetic silica glass substrate for photomasks according to claim 1, wherein the block of the synthetic silica glass is slowly cooled at a cooling rate of 0.8 to 1° C./min after heating at a temperature of 1100° C. or more in air.

8. A synthetic silica glass substrate for photomasks manufactured by the manufacturing method according to claim 1.

9. The synthetic silica glass substrate for photomasks according to claim 8 having maximum birefringence of 1.4 nm/cm or less and homogeneity of diffractive index of 2×10⁻⁵ or less.

10. The synthetic silica glass substrate for photomasks according to claim 8 having an average concentration of hydrogen atoms of 10¹⁸ to 10¹⁹ ppm.
